(19) United States
(12) Patent Application Publication
(10) Pub. No.: US 2012/0158420 A1
(43) Pub. Date: Jun. 21, 2012

(54) DETERMINING CLINICAL TRIAL CANDIDATES FROM AUTOMATICALLY COLLECTED NON-PERSONALLY IDENTIFABLE DEMOGRAPHICS

(75) Inventor: Jose C. Lacal, Boynton Beach, FL (US)

(73) Assignee: The Dolan Company, Minneapolis, MN (US)

(21) Appl. No.: 12/970,796

(22) Filed: Dec. 16, 2010

(51) Int. Cl. G06Q 50/00; G06Q 10/00

(52) U.S. Cl. 705/2

(57) ABSTRACT

Non-personally identifiable demographics associated with a patient during a communication session can be collected. The patient can be associated with one or more healthcare providers which can be associated with a one or more healthcare professionals. The demographics can be compared against a clinical trial profile associated with a clinical trial. The clinical trial profile can specify one or more target group parameters associated with a target group of the clinical trial. The clinical trial can be associated with a clinical research organization and/or a sponsor. When the comparing produces a match between the demographics and the profile, a clinical trial can be identified as suitable for the patient. Related apparatus, methods, systems and articles are also described.

### TECHNICAL FIELD

The current subject matter relates to the field of automated recruitment and, more particularly, to determining clinical trial candidates from automatically collected non-personally identifiable demographics.

### BACKGROUND

Organizations that fund clinical trials are commonly referred to as sponsors. These sponsors typically have a particular product such as a chemical compound and/or medical device which requires clinical testing on a clearly-defined target population (e.g., the target group). The target group typically shares a common health condition and/or physical characteristic that the product is intended to address. Ideally, the target group is defined as a diverse cross-section of a population which can enable the product to be tested in a comprehensive manner. In many instances, however, the candidate demographic of clinical trials often is considerably homogenous. That is, a majority of the candidates can often share many of the same characteristics (e.g., age group, race, etc.). This can severely impact the clinical trial resulting in inadequate testing, lengthy approval times, and delayed business objectives.

Frequently, clinical testing on the product must be performed before gaining approval by regulatory/supervisory agencies. In some instances, sponsors organize and run clinical testing for the product. In other instances, sponsors can utilize clinical research organizations (CROs) to assist in the clinical testing phase. CROs can often perform product clinical trials and/or recruit patients for the trials. For example, before a new drug can be placed on the consumer market with the United States, the sponsor of the drug must submit the drug to clinical trials in order to achieve approval by the Food and Drug Administration. Regulatory funding agencies are increasingly demanding the participation of elderly populations, children, women, racially and ethnically diverse communities, and medically underserved populations in clinical trials. As a result, both sponsors and CROs are required to spend enormous amounts of money, utilize very time-consuming, cumbersome, and expensive processes to be able to identify and recruit qualified candidates for the clinical trials.

Costs and time delays that result from advertising a clinical trial, interviewing candidates, determining candidate suitability, and the like are often adverse to business objectives as well as cost/time constraints for a clinical trial. These costs and time delays can grow considerably as the sponsor's product moves into later phases, requiring larger samples of populations. Subsequently, a new mechanism for obtaining a more diverse cross-section of a population defined across age groups, races, ethnic origin, and socio-economic status is highly favorable.

### BRIEF DESCRIPTION OF THE SEVERAL VIEWS OF THE DRAWINGS

FIG. 1 is a schematic diagram illustrating a system for determining clinical trial candidates from automatically collected demographics.

FIG. 2 is flowchart illustrating a method for determining clinical trial candidates from automatically collected demographics.

FIG. 3 is a schematic diagram illustrating an interface for determining clinical trial candidates from automatically collected demographics.

### DETAILED DESCRIPTION

The disclosure is a solution for determining clinical trial candidates from automatically collected non-personally identifiable demographics. The solution leverages resources to efficiently gather demographics of a patient associated with a healthcare provider to determine suitability for a clinical trial. Demographic information can be obtained automatically from one or more forms of contact with the patient including, but not limited to, telephone contact, Web-based contact, multi-modal contact (e.g., voice/text), and the like. Demographic information can be matched against a clinical trial profile to determine if a patient is eligible for a clinical trial. In one embodiment, matching demographic information against the clinical trial profile can be performed in real-time during a telephone answering service (TAS) call session. It should be appreciated that a TAS can include, but is not limited to, commercial operators, community information service operators, and the like. In the embodiment, clinical trials which match patient demographics can be automatically conveyed to a healthcare provider associated with patient. The healthcare provider can consult with the patient to assist the patient in determining a clinical trial which the patient can be interested in participating. It should be appreciated, confidentiality of information can be maintained throughout this process, so that sensitive patient information is never divulged to parties who would not inherently have this information without patient consent.

As will be appreciated by one skilled in the art, the current subject matter may be embodied as a system, method or computer program product. Accordingly, the subject matter described herein may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the subject matter described herein may take the form of a computer program product embodied in any tangible medium (e.g., a non-transitory medium, etc.) of expression having computer usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, for instance, via optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the subject matter described herein may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The subject matter described herein is described below with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. Methods as described herein can be implemented by one or more data processors which, in turn, can form part of a single computing system or a distributed computing system.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

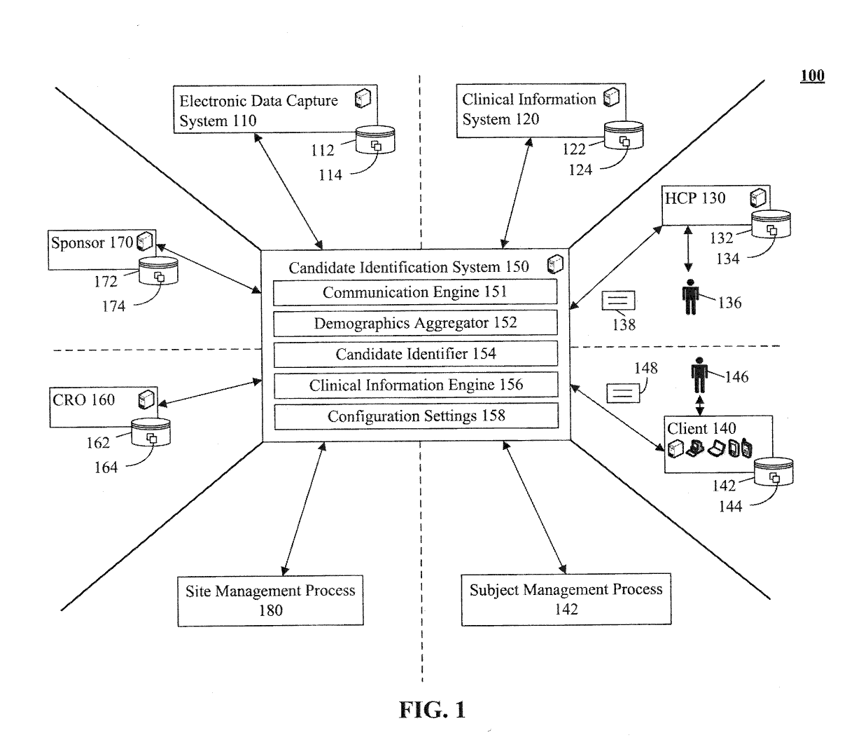

FIG. 1 is a schematic diagram illustrating a system 100 for determining clinical trial candidates from automatically collected demographics. System 100 illustrates one example of an information flow for determining clinical trial candidates. It should be appreciated other embodiments are contemplated. System 100 can comprise of elements 110-180 which can cooperatively function to permit rapid and automated identification of potential clinical trial candidates among one or more patients (e.g., patient 146). System 100 can enable increased diversity, variety, quality, and quantity of individuals applying for inclusion in clinical trials. In system 100, one or more elements 110-180 can be optionally omitted without affecting the functionality of system 100. System 100 can enable automated screening of patients 146 to determine the eligibility for clinical trials conducted by clinical research organization (CRO) 160 on behalf of sponsor 170 (e.g., pharmaceutical company). Utilizing the system 100 infrastructure can yield increased efficiency in obtaining clinical trial participants by leveraging multiple communication screening (e.g., telephony, Web, etc) technologies.

System 150 can be a component able to facilitate communication between elements 110-180. System 150 can enable comprehensive management for clinical trial candidate identification and participation. In one embodiment, system 150 can be a telephone answering service associated with a healthcare provider (HCP) 130. For instance, system 150 can be a call center service employed by provider 130 able to schedule appointments for patients 146 utilizing provider 130 services. In one instance, system 150 can be a component of a service oriented architecture (SOA) providing Web-enabled services to elements 110-180. In another embodiment, system 150 can be a component of a distributed computing environment, cooperatively operating to permit clinical trial recruitment through healthcare provider 130 associated services. In one instance, system 150 can operate in real-time or near real-time to provide instantaneous management of clinical trial and/or clinical trial participation.

As used herein, patient 146 can be a human agent receiving healthcare services from healthcare provider 130. Healthcare provider 130 can be an entity associated with healthcare professional 136 (e.g., doctor). When patient 146 initiates contact with system 150, non-personally identifiable demographics can be obtained. The demographics can include, but is not limited to, age, race, weight, height, location, medical condition, medical history, and the like. Obtained demographics can be utilized to identify a clinical trial associated with CRO 160 which can be of interest to patient 146. That is, the healthcare provider 130 can be informed of available clinical trials of interest based on collected demographics 148. For example, a patient 146 seeking a referral can anonymously provide demographic information (e.g., physical medical conditions) which can be collected during a telephone call. Upon communication with system 150, demographics 148 can be communicated to clinical information system 120 which can be utilized to determine patient 146 eligibility in available clinical trials 124. If a patient 146 is determined to be eligible for one or more clinical trials 124, system 150 can communicate the relevant clinical trials as a clinical trial listing 138 to provider 130. Communication of listing 138 can be performed at any time during interaction with system 150. Interaction with system 150 can include, but is not limited to, informational queries, appointment scheduling, and the like.

In one embodiment, listing 138 can be communicated to provider 130 upon patient termination of contact with system 150. For example, if a patient 146 communicates a call center 150 to inquire about a drug, drug information provided by the patient 146 can be used to identify potential clinical trials for which the patient 146 can be eligible, which can be communicated to the healthcare provider 136 when the patient terminates the call.

Additional non-personally identifiable demographics can be heuristically and/or semantically determined utilizing patient provided demographics to enable identification of clinical trials of interest. In one instance, patient 146 healthcare provider characteristics can be utilized to determine patient medical conditions and subsequently clinical trials of interest. For example, when a patient's healthcare provider is an oncologist, cancer-related clinical trials can be identified as possible clinical trials of interest for the patient 146. In another instance, Census information extracted from the caller's area code can be leveraged to determine patient socio-economic demographic characteristics including, but not limited to, location, race, gender, and the like. It should be appreciated, implementation specifics for usage of non-personally identifiable demographic information can vary based on information availability and/or accessibility.

Listing 138 can be a system 100 generated artifact for denoting one or more clinical trials which can be of interest to patient 146. Listing 138 can comprise of clinical trial name, patient demographics, location, clinical trial contact information, clinical trial tracking number, frequently asked questions, product information (e.g., drug being trialed), and the like. In one instance, listing 138 can be a real-time generated electronic document. For instance, listing 138 can be an ADOBE PORTABLE DIGITAL FORMAT (PDF) document which can be generated in response to patient 146 communication with system 150.

In one embodiment, system 100 can be a network computing environment including one or more data stores 112, 122, 132, 142, 162, 172 able to store information associated with clinical trials and clinical trial participation (e.g., patient 146 progress). In one configuration of the embodiment, the data stores 112, 122, 132, 142, 162, 172 can be independent of system 150. That is, each data store 112, 122, 132, 142, 162, 172 can be operated/owned by the associated entity 110, 120, 130, 140, 160, 170. In another configuration of the embodiment, information associated with system 150 (e.g., 114, 124, 134, 144, 164, 174) can be stored within a unified data store accessible by all entities within system 100. In the configuration, security mechanisms can be utilized to ensure clinical trial information is securely accessed by appropriate entities. For instance, clinical trial information can be compartmentalized to ensure privacy and security is maintained.

Candidate identification system 150 can be a hardware/software entity permitting improved candidate identification and referral for clinical trials 124. System 150 can comprise of, but is not limited to, communication engine 151, demographics aggregator 152, candidate identifier 154, clinical information engine 156, and configuration settings 158. System 150 can be an information technology infrastructure associated with a call center, healthcare provider service (e.g., hospital), emergency response service, healthcare insurance provider, and the like. System 150 can act as a centralized system within system 100 for coordinating the identification and recruitment of patients 146 into clinical trials. In one embodiment, system 150 can be a “drop-in” solution for diversifying clinical trial recruitment.

In one instance, system 150 can include application programming interfaces (API) which can be exposed to systems 110-140, 160, 170 and processes 142, 180 to enable end-to-end views of clinical trial participation. For instance, system 150 can include a front-end user interface such as a customizable portal for obtaining information about clinical trial recruitment.

In one embodiment, system 150 can be integrated with existing call centers permitting transparent upgrading of call center functionality. That is, call center can continue to function traditionally without requiring changes in operational policies. That is, no retraining/reeducating call center agents can be necessary and agent talk time can remain unchanged. Further, call center agents can be unaware of the underlying infrastructure providing system 150 functionality, which can be performed automatically without manual intervention from call center agents.

In one instance, specialized scripts can be generated to obtain relevant demographic information for a clinical trial. For instance, a call center agent can be dynamically presented with a script to obtain more information when a clinical trial match is identified for a patient 146 during a call.

Communication engine 151 can be a hardware/software component permitting communication between entities 110-140, 160, 170. Engine 151 can include user interface components and system interface components. In one instance, engine 151 can be a telecommunications engine able to perform telephony operations to facilitate system 100 functionality. In another instance, engine 151 can be a Web-based communications component permitting hypertext transport protocol (HTTP) communication between elements within system 100. In yet another instance, engine 151 can operate in a mixed communication mode enabling text-to-speech, speech-to-text and the like to be utilized within system 100. Further, engine 151 can provide notification communication for system 150 including, but not limited to communicating listing 138 to relevant entities within system 100. For instance, engine 151 can email a patient 146 a copy of the listing provided to healthcare provider 136. It should be appreciated that communication engine 151 can function uni-directionally and/or bi-directional depending on system 150 configuration and/or element 110-180 configuration.

Demographics aggregator 152 can be a hardware/software component able to collect demographic information from patient 146. Aggregator 152 can utilize presence information, speech recognition, and the like to automatically determine demographics about patient 152. In one embodiment, aggregator 152 can be linked to a user interface which can collect user input (e.g., call center agent) about a patient 146. In one example, as a call center agent retrieves a patient record, aggregator 152 can automatically collect non-personally identifiable information from the record. Aggregator 152 can receive input via voice, dial-tone multi-frequency (DTMF) signaling, text parsing, and the like. Demographics aggregator 152 can utilize functionality of intelligent networks to determine a patient 146 location. For example, a patient 146 phone number can be used to determine a clinical trial near the patient's 146 healthcare professional 136.

Candidate identifier 154 can be utilized to determine the eligibility of a patient 146 in participating in a clinical trial. The identifier 154 can utilize profile 124 information and demographics 148 to determine the suitability of a patient 146. Identifier 154 can generate a confidence score indicating the likelihood a patient 146 is suitable for a selected clinical trial. In one instance, the confidence score can be conveyed with listing 138 to provider 130 to assist healthcare professional 136 in the decision making process. Confidence score can compared to a pre-determined threshold value which can be a setting associated with a clinical trial, system 150, CRO 160, sponsor 170, and the like. In one embodiment, the confidence score can be compared to the pre-determined threshold value to enable a programmatic decision making process to occur. The result of the programmatic decisions process can be used to automatically determine if a clinical trial is suitable for a candidate.

In one instance, identifier 154 can track patient 146 eligibility and enrollment enabling auditing processes to be enacted. In the instance, based on an eligibility-enrollment ratio, success rates for recruitment can be determined which can be used to improve system 150 selection. It should be noted, metrics (e.g., success rates) obtained by system 150 can be used to monetize the disclosure via one or more business models including, but not limited to, revenue sharing (e.g., per-lead revenue models), contingent fee models (e.g., success fees), and the like.

Clinical information engine 156 can be a component able to facilitate integration of clinical processes into system 100. Engine 156 can process clinical trial information including, but not limited to, information 114, 124, 138, 148, 164, 174. Engine 156 can be a text processing engine, computational modeling engine, and the like. Further, engine 156 can give rise to subject management processes 142 and site management process 180 which can enable actors within system 100 to seamlessly interact with system 100 at varying degrees of granularity. Engine 156 can be utilized to provide patient 146 with relevant information about clinical trials which the patient 146 can be eligible.

Configuration settings 158 can permit system 150 to be flexibly configured for any element 110-140, 160, 170 and/or environment. Settings 158 can be used to configure access policies, security clearances, management functionality, and the like. For instance, settings 158 enable system 150 to collect demographics from a patient from multiple forms of contact. Settings 158 can enable selected demographics to be collected based on CRO 160 requirements, clinical trial profile settings, and the like. Further, configuration settings 158 can be used to establish the manner in which clinical trials are selected. In one embodiment, prioritization of clinical trial profile criteria can be enacted to tailor candidate identification based on clinical trial objectives, patient 146 parameters, and the like.

Electronic data capture system (EDC) 110 can provide automated data capture functionality within system 100. EDC 110 can include, but is not limited to, data store 112 and electronic data 114. EDC functionality can include, but is not limited to, clinical study management features, clinical data submission and/or validation, data filtering and/or extraction, clinical study oversight, auditing, and/or reporting, clinical case report form processing/management, and the like. EDC 110 can be integrated with system 150 to provide real-time electronic collection of information during clinical trials. Information collected from EDC 110 can be directly inputted into system 150 through one or more mechanisms and vice-versa.

Clinical information system 120 can be a hardware/software component able to interact with system 150 to provide clinical trial candidate identification functionality. Clinical information system 120 can include, but is not limited to, data store 122 and clinical trial profile 124. Clinical trial profile 122 can include, but is not limited to, clinical trial name, phase, location (e.g., site), participant demographics (e.g., age, race, etc), clinical trial tracking number, and the like. It should be appreciated that system 120 can act as an information repository able to respond to clinical trial profile queries from system 150. In one embodiment, system 120 can be a semantic search engine for health data. In the embodiment, system 120 can interface with system 150 to provide relevant candidate information (e.g., demographics). In one instance, system 120 can be a component or sub-component of system 150. In the instance, system 120 can collect and/or aggregate clinical trials from one or more sources, including, but not limited to, sponsor 170, CRO 160, private databases, public databases. For example, system 120 can utilize a Web-enabled database (e.g., clinicaltrials.gov) as a public data source for obtaining clinical trial information.

Healthcare provider (HCP) 130 can be a an entity able to send and/or receive clinical trial participant information with system 150. Provider 130 can be associated with healthcare professional 136. Healthcare professional 136 can be an institution and/or an individual delivering health-related care to individuals (e.g., patient 146). Professional 136 can include, but is not limited to, a medical practice staff, a physician, a specialist, a nurse, a technician, and the like. Professional 136 can interact with provider 130 to administer health-related care to patient 146.

Provider 130 can be a informational technology component of a healthcare provider organization. Provider 130 can include, computing devices, medical devices, and the like. Provider 130 can include, but is not limited to, data store 132, clinical trial listing 134, and the like. Provider 130 can be associated with one or more organizational entities, but is not limited to, a hospital, a medical practice, a pharmacy, and the like. For instance, provider 130 can be a local area network associated with a medical practice. In one instance, provider 130 can receive clinical trial listing 138 from system 150 in response to a patient 146 communication with system 150. Provider 130 can receive listing 138 in one or more digital and/or analog forms which can be presented to professional 136. Once obtained, professional 136 can present listing 138 to patient 146 when the professional 136 meets with the patient 146. For instance, a hardcopy of listing 138 can be sent via postal mail to a healthcare professional 136 servicing patient 146, which can be presented to patient 146 upon appointment fulfillment.

Client 140 can be a hardware/software entity for permitting patient 146 to interact with system 150. Client 140 can include, but is not limited to data store 142, healthcare information 144, and patient 146. Healthcare information 144 can include, but is not limited to, appointment information, clinical trial listing, clinical trial tracking number, healthcare provider information, and the like. In one instance, client 140 can be a mobile phone able to interface with a voice user interface associated with system 150.

Clinical research organization 160 can be one or more entities able to conduct and/or manage clinical trial associated with clinical trial information 164. Organization 160 can include organizational elements, computing devices, and the like. Organization 160 can include one or more research organizations, affiliate organizations/entities, and the like. Organization 160 can include one or more trial sites able to conduct clinical trial information 164. Organization 160 can communicate enrollment criteria to system 150 which can be used in determining suitable candidates for clinical trials.

Sponsor 170 can be one or more organizations providing a product being tested within clinical trials conducted by CRO 160. Sponsor 170 can include organizational elements, computing devices, and the like. Sponsor 170 can be, but is not limited to, pharmaceutical organization, government organization, military organization, private organization, and the like. Sponsor 170 can include computing entities such as data store 172, product information 174, and the like. Product information 174 can include, drug information, product defect information, and the like.

Drawings presented herein are for illustrative purposes only and should not be construed to limit the current subject matter in any regard. It should be appreciated that system 100 can illustrate one or more business processes for recruiting candidates for clinical trials. Elements 110-140, 160, 170 can include computing devices including, but not limited to, desktop computers, computer servers, laptops, mobile phones, portable digital assistant (PDA), and the like. In one embodiment, system 100 can be a cloud-based service which can provide integration into existing systems without requiring modification to the existing systems. For example, system 100 can be a subscription based service available to each element within system 100. In one instance, system 100 can include a presence aware component, speech processing component, auditing component, commission transaction component, and the like. System 150 can be integrated to utilize public data stores including, but not limited to, mailing lists, drug information repositories, and the like. Further, system 150 can be utilized to analyze historic call records to determine eligible candidates for current and future clinical trials.

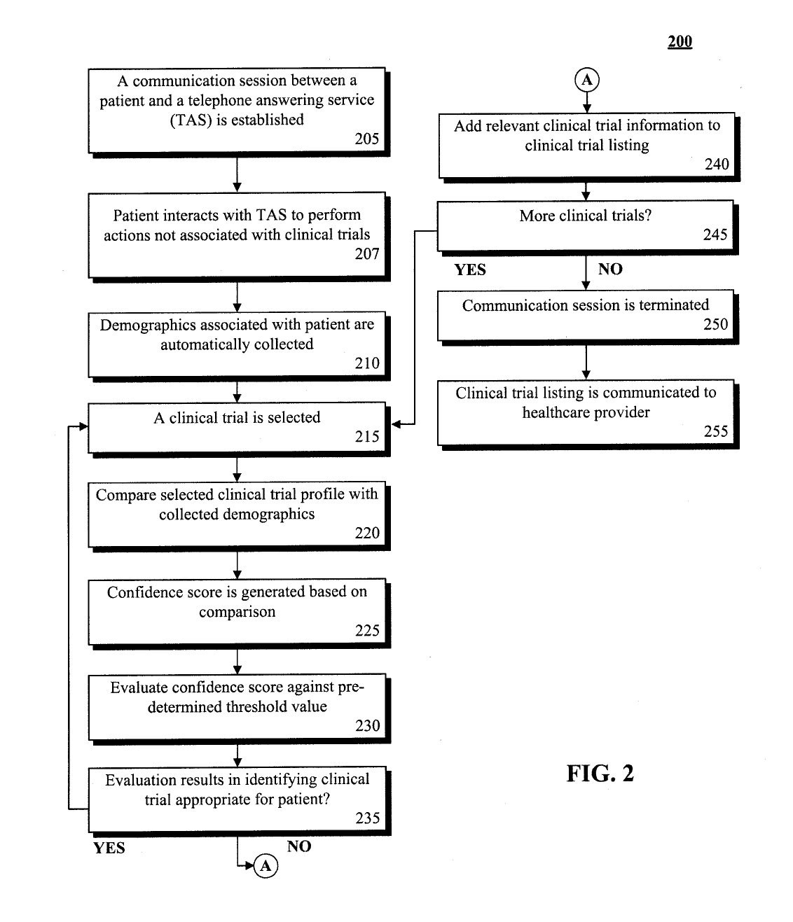

FIG. 2 is a flowchart illustrating a method 200 for determining clinical trial candidates from automatically collected demographics. Method 200 can be performed in the context of system 100. In method 200, a communication session can be established by a patient with a telephone answering service. The patient can interact with the telephone answering service to perform tasks not related to a clinical trial (e.g., scheduling an appointment). The patient can complete the interaction with the telephone answering service in a traditional manner. For instance, a patient can call a telephone answering service associated with their primary care physician to schedule an appointment meeting. It should be appreciated that the patient can be unaware of steps 210-245 being automatically performed. That is, the method can be performed in a user transparent manner without requiring manual user intervention.

In step 205, a communication session between a patient and a telephone answering service (TAS) can be established. The communication session can include a telephony communication, a Web-based communication, text-based communication (e.g., Internet chat), audio/video conference communication, and the like. In step 207, the patient can interact with the TAS to perform actions not associated with clinical trials. In step 210, non-personally identifiable demographics associated with the patient can be automatically collected. Collection of demographics can be performed via voice recognition, presence identification services, and the like. For instance, when a patient uses a mobile phone to call the call center, wireless carrier information can be used to determine the patient's phone number, location, residence, and the like. In step 215, a clinical trial can be selected from a pool of available clinical trials. The clinical trial can be selected based on one or more criteria including, but not limited to, clinical trial phase criteria, clinical trial length, sponsor, and the like. In step 220, the selected clinical trial profile can be compared with the collected demographics. In step 225, a confidence score can be generated based on the comparison. The confidence score can be generated using one or more weighted values, priority settings, and the like. For instance, when a clinical trial profile requires a patient to be within a specific age group, the confidence score can be weighted to reflect the requirement.

In step 230, the confidence score can be evaluated against a pre-determined threshold value. In step 235, if evaluation results in identifying the selected clinical trial are appropriate for the patient, the method can proceed to step 215, else continue to step 240. In step 240, relevant clinical trial information for the selected clinical trial can be added to a clinical trial listing. In step 245, if more clinical trials are available, the method can proceed to step 215, else continue to step 250. In step 250, the communication session can be terminated. Termination can include, hanging up a call, closing a Web browser window, logging out, and the like. In step 255, the clinical trial listing can be communicated to a healthcare provider associated with the patient. The clinical trial listing can be communicated through one or more forms of analog and digital mechanism including, but not limited to, postal mail, email, fax, and the like.

The health care provider can then assess the information about the possible clinical trials available to his/her patient. The health care provider can determine whether the patient in his/her professional opinion may benefit from any of the targeted trials and may selectively inform the patent of these trials based on his/her medical judgment. It should be appreciated that the medical professional need not research which trials are available and relevant to a patient, as this information is automatically determined and provided to the physician in step 255.

It should also be appreciated that the clinical information system (e.g., system 120) that is providing the clinical trials may not be informed of the patient identity or that the physician was provided with a listing of trials applicable to patients. Thus, no pressure (or even knowledge) of the clinical trials is conveyed to the clinical trial system (or entities conducting the clinical trial) until and unless a patent decides to participate. Further, multiple privacy mechanisms within system 100 and method 200 can be integral characteristics, enabling controlled information disclosure to actors. That is, actors interacting with system 100 and method 200 can be protected from unwanted dissemination of confidential information. For example, method 100 can enable privacy by permitting clinical trial information to be issued to a professional (e.g. healthcare professional 136) without requiring the professional and the patient associated with the professional to be personally identified. In one embodiment, configuration settings (e.g. configuration settings 158) can be utilized to establish privacy filters (e.g., blinders) within the method, enabling privacy to be maintained.

When the patient visits the physician, he/she is provided with a set of possible clinical trials to which he/she qualifies. Each of these clinical trials can include a contact option for participating in the trial, as well as an identification number, which indicates that the trial was advised through method 200. The contact option can include, a phone number, an email address, a Uniform Resource Locator (URL), and the like. When a patient elects to initiate contact with an entity associated with a clinical trial (e.g., clinical research organization), one or more contact options provided to the patient can be used. Subsequent to the contact, the entity conducting the clinical trial can compensate the referral source (likely the system 150, which can include a call center, a provider of call center software, and/or other such entities).

It should be appreciated that in one embodiment, neither the physician nor the call in center need are directly informed as to which candidates have opted to participate in clinical trials. The referral compensation can be conducted in an identity protecting manner. Thus, patient confidentiality and choice is preserved throughout this entire method through selective isolation of information.

Drawings presented herein are for illustrative purposes only and should not be construed to limit the current subject matter in any regard. Method 200 can be a sub-process within a business process utilized within a healthcare infrastructure.

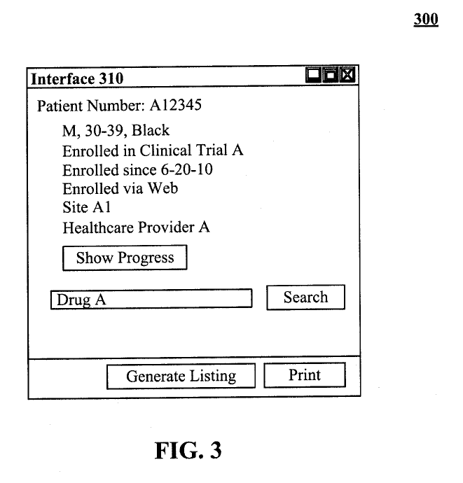

FIG. 3 is a schematic diagram illustrating an interface 310 for determining clinical trial candidates from automatically collected demographics.

Drawings presented herein are for illustrative purposes only and should not be construed to limit the current subject matter in any regard. In one instance, interface 310 can be used to generate a listing manually by a call center agent. In the instance, interface 310 can receive patient demographic information from one or more screens which can be presented to the call center agent.

The flowchart and block diagrams in the FIGS. 1-3 illustrate the architecture, functionality, and operation of possible implementations of systems, methods and computer program products according to various embodiments of the subject matter described herein. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for automatically identifying clinical trial candidates, the method being implemented by one or more data processors and comprising:
collecting, by least one data processor, a plurality of non-personally identifiable demographics during a communication session associated with a patient, wherein the patient is associated with a healthcare provider, wherein the healthcare provider is associated with a plurality of healthcare professionals;
comparing, by least one data processor, the plurality of non-personally identifiable demographics against a clinical trial profile associated with a clinical trial, wherein the profile specifies a plurality of target group parameters associated with a target group of the clinical trial, wherein the clinical trial is associated with at least one of a clinical research organization and a sponsor; and
identifying, by at least one data processor, the clinical trial is suitable for the patient when the comparing produces a match between the plurality of non-personally identifiable demographics and the profile.

2. The method of claim 1, further comprising:
providing, by least one data processor, a healthcare professional with a listing of clinical trials suitable for the patient, wherein the listing is provided along with the collected non-personally identifiable demographics that is unrelated to clinical trials of the listing, wherein each listing is optionally presented to the patient at the time of their meeting, wherein each listing provides at least one contact option for contacting a corresponding clinical trial entity.

3. The method of claim 2, wherein the listing is generated in response to a patient telephoning a call center for purposes of arranging a meeting with a healthcare professional.

4. The method of claim 1, wherein an entity associated with collecting of the non-personally identifiable demographics receives a referral fee responsive to a patient utilizing the at least one contact option.

5. The method of claim 1, further comprising
automatically collecting, by least one data processor, the non-personally identifiable demographics and semantically identifying a second non-personally identifiable demographics associated with the non-personally identifiable demographics, wherein the second non-personally identifiable demographics is compared against the clinical trial profile, wherein the non-personally identifiable demographics and the second non-personally identifiable demographics indicate at least two criteria, wherein the at least two criteria are a gender, an age, a location, and a medical condition.

6. The method of claim 2, wherein the clinical trial entity is not provided any information about a patient until and unless the patient initiates a communication with the clinical trial entity.

7. The method of claim 1, further comprising:
performing, by least one data processor, a routing action on the telephony session resulting in the telephony session being terminated at a clinical recruiting agency associated with the clinical trial.

8. The method of claim 1, further comprising:
presenting, by least one data processor, the patient with a tracking number, wherein the tracking number is associated with the patient and the identified clinical trial, wherein the tracking number enables enrollment of the patient with the identified clinical trial.

9. The method of claim 1, wherein the match is associated with a confidence score, wherein the confidence score indicates a correspondence between the plurality of the non-personally identifiable demographics and the plurality of target group parameters, wherein the correspondence determines the likelihood the patient is a suitable candidate for the identified clinical trial.

10. A system for automatically identifying clinical trial candidates comprising:
a processor;
a volatile memory;
a bus connecting the processor, non-volatile memory, and volatile memory to each other, wherein the volatile memory comprises computer usable program code execute-able by the processor, the computer usable program code comprising:
a demographics engine to automatically determine a plurality of patient demographics associated with a patient during a communication session, wherein the demographics are not personally identifiable information;
a candidate engine to match the plurality of patient demographics with a profile associated with a clinical trial, wherein the profile is associated with a plurality of target group parameters, wherein the clinical trial is associated with at least one of a clinical research organization and a sponsor; and
a clinical information engine to receive a clinical trial enrollment request from the patient wherein the enrollment request is associated with a tracking number.

11. The system of claim 10, wherein the candidate engine generates a confidence score based on a comparison of the plurality of patient demographics with the target group parameters.

12. The system of claim 10, wherein the clinical information engine is associated with an interface permitting management of clinical trial information associated with the patient, wherein the clinical trial information is non-personally identifiable information.

13. The system of claim 10, wherein the clinical information engine programmatically presents information associated with a clinical trial to a healthcare professional.

14. The system of claim 10, wherein the clinical information engine presents a clinical case report form to a healthcare professional.

15. The system of claim 10, wherein the clinical information engine collects clinical trial information in real-time of a patient participating in a clinical trial, wherein the patient is enrolled within a clinical using the tracking number.

16. The system of claim 10, wherein the enrollment request is performed by a healthcare provider associated with the patient utilizing a tracking number linked to the patient.

17. A method for automatically identifying clinical trial candidates, the method being implemented by one or more data processors and comprising:
receiving, by at least one data processor, a plurality of non-personally identifiable demographics during a communication session associated with a patient, wherein the patient is associated with a healthcare provider, wherein the healthcare provider is associated with a plurality of healthcare professionals;
identifying, by at least one data processor, a clinical trial profile associated with a clinical trial, wherein the profile specifies a plurality of target group parameters associated with a target group of the clinical trial, wherein the clinical trial is associated with at least one of a clinical research organization and a sponsor;
programmatically comparing, by at least one data processor, the plurality of non-personally identifiable demographics against the plurality of target group parameters associated with the clinical trial profile;
generating, by at least one data processor, a clinical trial listing when the comparing produces a match between the plurality of non-personally identifiable demographics and the target group parameters, wherein the clinical trial listing indicates the patient is suitable for the clinical trial, wherein the clinical trial listing is associated with a unique tracking number, wherein the tracking number enables enrollment of the patient with a clinical trial associated with the identified clinical trial profile, wherein the clinical trial listing provides at least one contact option for contacting a corresponding clinical trial entity.

18. The method of claim 1, further comprising:
providing, by at least one data processor, a healthcare professional with clinical trial listing, wherein the listing is provided along with the collected non-personally identifiable demographics that is unrelated to clinical trial listing, wherein the listing is optionally presented to the patient during a meeting with the healthcare professional.

19. The method of claim 17, wherein the listing is generated in response to a patient telephoning a call center for purposes of arranging a meeting with a healthcare professional.

20. The method of claim 17, wherein an entity collecting the non-personally identifiable demographics receives a referral fee responsive to a patient utilizing the at least one contact option.
